(19) United States
(12) Patent Application Publication
(10) Pub. No.: US 2016/0102980 A1
(43) Pub. Date: Apr. 14, 2016

(54) Sensor Element and Method for Capturing a First and a Second Component of a Physical Variable

(71) Applicant: ROBERT BOSCH GMBH, Stuttgart (DE)

(72) Inventor: Reinhard Neul, Stuttgart (DE)

(21) Appl. No.: 14/890,747

(22) PCT Filed: Apr. 16, 2014
(86) PCT No.: PCT/EP2014/057736

§ 371 Date: Nov. 12, 2015

(30) Foreign Application Priority Data
May 15, 2013 (DE) 10 2013 208 948.1

(51) Int. Cl. G01C 19/5776; G01P 15/02

(52) U.S. Cl. CPC G01C 19/5776; G01P 15/02

(57) ABSTRACT

The disclosure relates to a sensor element for capturing a first and a second component of a physical variable. The sensor element comprises a first measuring transducer for measuring a first component, directed in a first measuring direction, of the physical variable. The sensor element further comprises a second measuring transducer for measuring a second component, directed in a second measuring direction, of the physical variable, wherein the first and second measuring transducers are formed or arranged on or in a carrier substrate, which contains a material on or in which measuring transducers can be produced during processing with a predefined processing method, said measuring transducers being formed to measure the physical variable in a first or second measuring direction, wherein a measuring angle between the first and the second measuring direction depends on the material of the carrier substrate.

### PRIOR ART

The present invention relates to a sensor element and to a method for acquiring a first and a second component of a physical quantity, and to a corresponding computer program product.

Many inertial sensors, for example rotation rate sensors and/or acceleration sensors, are produced by plasma etching methods. Particularly in the case of rotation rate sensors, fabrication tolerances are a particular disadvantage. Fabrication methods which allow low tolerances (for example the KOH etching technique) for their part do not make it possible to arrange the sensor cores for the various measurement directions with respect to one another usably on the sensor chip.

DE 103 25 548 A1 discloses a device and a method for measuring movement quantities.

### DISCLOSURE OF THE INVENTION

Against this background, the present invention provides a sensor element and a method for acquiring a first and a second component of a physical quantity, and lastly a corresponding computer program product, according to the main claims. Advantageous configurations may be found in the respective dependent claims and the description below.

The approach proposed here provides a sensor element for acquiring a first and a second component of a physical quantity, wherein the sensor element has the following features:
a first measuring transducer for recording a first component of the physical quantity pointing in a first recording direction; and
a second measuring transducer for recording a second component of the physical quantity pointing in a second recording direction,
   wherein the first and second measuring transducers are formed or arranged on or in a carrier substrate which comprises a material on or in which, by processing with a predetermined processing method, it is possible to produce measuring transducers which are configured in order to record the physical quantity in a first or second recording direction, wherein a recording angle between the first and second recording directions is dependent on the material of the carrier substrate.

The approach proposed here furthermore provides a method for producing a sensor element for acquiring a first component and a second component of a physical quantity, wherein the method comprises the following steps:
providing a carrier substrate which comprises a material in or on which, by processing with a predetermined processing method, it is possible to produce measuring transducers which are configured in order to record the physical quantity in a first or second recording direction, a recording angle between the first and second recording directions being dependent on the material of the carrier substrate;
arranging a first measuring transducer for recording a first component of the physical quantity pointing in the first recording direction and a second measuring transducer for recording a second component of the physical quantity pointing in the second recording direction.

The approach proposed here furthermore provides a sensor signal processing device for operating a variant of a sensor element as proposed here, wherein the sensor signal processing device has the following features:
an interface for reading in the first and second components of the physical quantity; and
a processing unit for determining a fraction of the physical quantity in the first reference direction on the basis of a first combination rule for combining the first component with the second component, and/or for determining a fraction of the physical quantity in the second reference direction on the basis of a second combination rule for combining the first component with the second component, the processing unit being configured in order to determine the fraction of the physical quantity in the first reference direction on the basis of a first combination rule for combining the first component with the second component, and/or in order to determine the fraction of the physical quantity in the second reference direction on the basis of a second combination rule for combining the first component with the second component.

The present approach also provides a method for acquiring a first and a second component of a physical quantity with a variant of an approach as proposed here, wherein the method comprises the following steps:
reading in the first and second components of the physical quantity; and
determining the fraction of the physical quantity in the first reference direction on the basis of a first combination rule for combining the first component with the second component, and/or determining the fraction of the physical quantity in the second reference direction on the basis of a second combination rule for combining the first component with the second component.

The approach described here furthermore provides a device which is configured in order to carry out or implement the steps of a variant of a method as proposed here in corresponding equipment. In this alternative embodiment of the invention as well, in the form of a device, the object of the invention can be achieved rapidly and efficiently.

In the present case, a device may be understood as being an electrical apparatus which processes sensor signals and outputs control and/or data signals as a function thereof. The device may have an interface, which may be configured as hardware and/or software. In a hardware configuration, the interfaces may, for example, be part of a so-called ASIC system which contains a very wide variety of functions of the device. It is, however, also possible for the interfaces to be separate integrated circuits or at least partially consist of discrete components. In a software configuration, the interfaces may be software modules which, for example, are present on a microcontroller in addition to other software modules.

A device for operating a sensor element according to a variant of the sensor element proposed here is therefore provided, wherein the first measuring transducer is arranged in such a way that the first recording direction is oriented at a first angle, dependent on the recording angle, in relation to the first reference direction, and/or wherein the second measuring transducer is arranged in such a way that the second recording direction is oriented at a second angle, dependent on the recording angle, in relation to the second reference direction, the device having the following features:
an interface for reading in the first and second components of the physical quantity; and
a unit for determining a fraction of the physical quantity in the first reference direction on the basis of a first combination rule for combining the first component with the second component, and/or for determining a fraction of the physical quantity in the second reference direction on the basis of a second combination rule for combining the first component with the second component.

Also advantageous is a computer program product with program code which may be stored on a machine-readable medium such as a semiconductor memory, a hard-disk memory or an optical memory and is used to carry out the method according to one of the embodiments described above when the program product is run on a computer or a device. A computer program product with program code for carrying out the method according to an embodiment proposed here, when the program product is run on a device, is therefore also provided here.

In the present case, a physical quantity may be understood as a physically measurable parameter, for example a rotation rate, an acceleration or the like. Here, a component may be understood as a signal which represents a fraction of the physical quantity in a particular direction. A measuring transducer may be understood as a sensor which is configured in order to convert at least the first and/or second components of the physical quantity into a signal, for example an electrical signal. A recording direction may be understood as a direction in which a component of the physical quantity acts. A carrier substrate may be understood as a material with a predefined structure, for example a lattice structure or a crystalline or semiconductor material, which makes it possible to apply or fabricate a measuring transducer within this carrier substrate. In this case, a configuration of the recording directions of different measuring transducers in the carrier substrate is dependent not only on the processing method (for example a particular structure mask when using an etching method), but on the material itself. In this way, the formation of different measuring transducers formed in the carrier substrate is restricted in terms of their recording directions, since the formation of the measuring transducers in the carrier substrate only allows orientation of a recording direction in one of a few possible recording directions. The recording directions, in which the measuring transducers that can be formed in the material of the carrier substrate may be oriented, are predetermined in a by the material or a lattice structure of the material of the carrier substrate. These recording directions are therefore oriented with respect to one another at a recording angle dependent on the material (possibly in conjunction with a processing method for this material).

The approach proposed here is based on the discovery that with a known, economical and established production method, it is now possible to produce, or use for data delivery, a sensor element which can acquire components of a physical quantity from almost any desired directions. This makes it possible to use a recording angle, between the different recording directions of the relevant measuring transducers, which is dictated by physical effects during the production of the sensor element. The signals provided by such a sensor element, which correspond to the first and/or second component of a physical quantity, may according to another embodiment of the present invention subsequently be converted into reference components of any desired reference coordinate system (for example with orthogonally arranged axes).

The approach proposed here now offers the advantage that elaborate adjustment or cost-intensive production of a special sensor element is not required in order to acquire components of the physical quantity in those directions which correspond to axes of the reference coordinate system. Rather, with a sensor element that can be produced economically and by standard methods, it is now possible to acquire components of the physical quantity in recording directions which can be acquired by measuring transducers that are formed economically in or on the carrier substrate by the standard method. Transformation of the components of the physical quantity, pointing in the recording directions, into reference components that point along the axes of a reference coordinate system may then be carried out by a conversion that can be performed straightforwardly by circuit technology or digitally.

An embodiment of the present invention in which the sensor element is configured in order to determine at least one fraction of the physical quantity in a first and/or second reference direction, the first measuring transducer being arranged in such a way that the first recording direction is oriented at a first angle, dependent on the recording angle, in relation to the first reference direction and/or the second measuring transducer being arranged in such a way that the second recording direction is oriented at a second angle, dependent on the recording angle, in relation to the second reference direction, is particularly favorable. Such an embodiment of the present invention offers the advantage that, by virtue of the particular arrangement of the recording directions of the first and/or second measuring transducer, a signal/noise ratio can be influenced in a controlled way and therefore optimized.

According to a particularly favorable embodiment of the present invention, the first and second measuring transducers may be arranged in such a way that the first and second recording directions are oriented symmetrically around an angle bisector of an angle between the first and second reference directions. Such an embodiment of the present invention offers the advantage that a maximum possible signal/noise ratio can be achieved.

An embodiment of the present invention may also be envisioned in which a processing unit is provided, which is configured in order to determine the fraction of the physical quantity in the first reference direction on the basis of a first combination rule for combining the first component with the second component, and/or in order to determine the fraction of the physical quantity in the second reference direction on the basis of a second combination rule for combining the first component with the second component. A combination rule may be understood as a mathematical or algebraic rule for converting a value representing the components into a value which represents the fraction of the physical quantity in the reference direction. A reference direction may be understood as a direction of an axis of a (reference) coordinate system, into which the fractions of the physical quantity are intended to be converted. Such a processing unit may, for example, be an electronic device which reads in data signals and outputs corresponding processed data signals. Such an embodiment of the present invention offers the advantage that the sensor element is in the form of an integrated component that provides output signals which represent the components of the physical quantity in the (two desired) reference directions. The output signals of such a sensor element can therefore be processed further very straightforwardly and without further conditioning in other data processing units (for example an airbag control unit) with little outlay. Such an embodiment of the present invention therefore offers the advantage that such a sensor element outputs output signals which can be used directly by a further data processing unit without further processing.

An embodiment of the present invention in which the processing unit is configured, for determining the fraction in the first reference direction, in order to weight the first component with a first factor and to combine it, in particular additively, with the second component weighted with a second factor, and/or wherein the processing unit is configured, for determining the fraction in the second reference direction, in order to weight the first component with a further factor and combine it, in particular additively, with the second component weighted with an additional factor, is particularly straightforward to implement in technical terms. Such an embodiment of the present invention offers the advantage of allowing conversion between the components of the physical quantity into the relevant fractions of the physical quantity in the corresponding reference directions by a very straightforward combination rule.

According to one particular embodiment of the present invention, the processing unit may be configured in order to use a first, second, further and/or additional factor, which is dependent on the first and second angles. Such an embodiment of the present invention offers the advantage that a corresponding factor is respectively dependent on both components determined by the sensor element, and precise determination of the fraction of the physical quantity in the corresponding reference direction is therefore made possible.

An embodiment of the present invention in which the twisting or distortion is taken into account by the transformation of the components, acquired in the recording directions, of the physical quantity into the fractions of the physical quantity in the reference directions on the basis of geometrical relationships is particularly advantageous. In such an embodiment of the present invention, the processing unit may be configured in order to use

$${a}_{1} = - \frac{cos β}{sin ( α + β )} ;$$

as the first factor,

$${b}_{1} = \frac{cos α}{sin ( α + β )}$$

as the second factor,

$${a}_{2} = \frac{sin β}{sin ( α + β )}$$

as the further factor,
and/or

$${b}_{2} = \frac{sin α}{sin ( α + β )}$$

as the additional factor,
α representing the first angle and β representing the second angle. This procedure can very precisely determine the fraction of the physical quantity in the first and/or second reference direction, so that a high signal/noise ratio can be achieved.

Furthermore, an embodiment of the present invention as a sensor system having a variant of a sensor element as proposed here and a variant of a sensor signal processing device as proposed here is favorable. Such an embodiment of the present invention offers the advantage of a compact structure of a sensor system, in which adaptation of the parameters and factors necessary for the processing of the components in the sensor signal processing device may already be stored directly in the sensor signal processing device. In this way, without a further processing unit, the sensor system can already deliver signal values which can be interpreted by a further data processing unit as fractions of the physical quantity in the reference directions.

The invention will be described more detail below by way of example with the aid of the appended drawings, in which:

FIG. 1 shows a schematic representation of a sensor element according to one exemplary embodiment of the present invention;

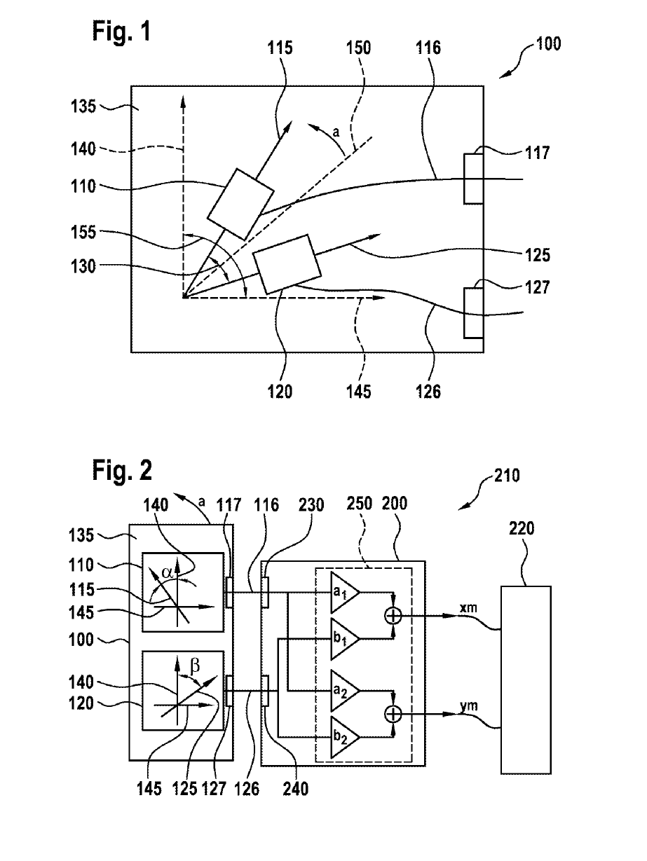

FIG. 2 shows a block diagram of a sensor system which comprises a sensor signal processing device and a sensor element according to exemplary embodiments of the present invention;

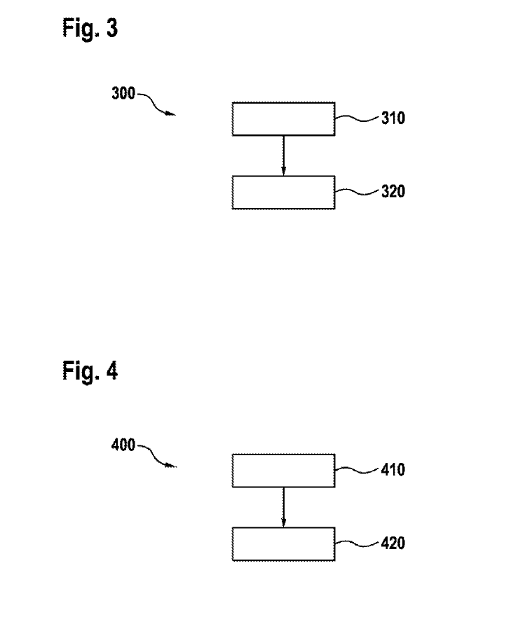

FIG. 3 shows a flowchart of a method for producing a sensor element according to one exemplary embodiment of the present invention; and

FIG. 4 shows a flowchart of a method for operating a sensor signal processing device according to one exemplary embodiment of the present invention.

In the following description of favorable exemplary embodiments of the present invention, identical or similar references are used for the elements represented in the various figures and similarly acting elements, repeated description of these elements being omitted.

FIG. 1 shows a schematic representation of a sensor element 100 according to one exemplary embodiment of the present invention. In this case, the sensor system comprises a first measuring transducer 110, which is configured in order to acquire a component of a physical quantity a, for example a rotation rate and/or an acceleration, in a first recording direction 115. The component acquired by the first measuring transducer 110 in the first recording direction 115, or more precisely a first signal 116 which represents the first component, may be provided at a first signal connection 117 of the sensor element 100.

The sensor element 100 furthermore comprises a second measuring transducer 120, which is configured in order to acquire a component of a physical quantity a in a second recording direction 125 different to the first recording direction 115. The component acquired by the first second measuring transducer 120 in the second recording direction 125, or more precisely a second signal 126 which represents the second component, may be provided at a second signal connection 127 of the sensor element 100. In this case, the first measuring transducer 110 and the second measuring transducer 120 may be arranged in such a way that an angle 130 between the first recording direction 115 and the second recording direction 125 is dictated by a material of a carrier substrate 135, on or in which the measuring transducers 110 and 120 are formed or embedded. The angle 130 may, for example, in this case be dictated by a crystal lattice structure of a semiconductor material which is used as a carrier substrate 135. For example, structures may be produced in predetermined edge directions by a semiconductor fabrication method which is economical to carry out (for example etching with a particular etchant in combination with a particular semiconductor material). These edges, which may be generated by the production method which is economical to use, may in this case make an angle in the edge directions which differs from 90°, but which would in turn be advantageous for favorable evaluation of the signals of the measuring transducers in a further processing unit. For example, by using a KOH etchant applied to a silicon semiconductor crystal, it is possible to produce edges which are misaligned with one another by an angle of 70.53°. In order to be able to process the measurement values or measurement signals of the measuring transducers 110 and 120 with conventional signal processing units, a twisted arrangement of the measuring transducers 110 and 120 on the carrier substrate would be necessary, so that the signals provided at the interfaces 117 and 127 represent fractions of the physical quantity in a first reference direction 140 and a second reference direction 145, respectively, the first reference direction 140 and the second reference direction 145 being, for example, oriented at an angle of 90 degrees with respect to one another. This “twisted” arrangement of the measuring transducers 110 and 120 would, however, require increased outlay during the production of the sensor element 100, since for example it is not possible to employ economical production methods and for the configuration of the measuring transducers in the carrier substrate 135.

In order now to allow an improvement of the acquisition of the physical quantity by economical but nevertheless precisely operating means, in the approach proposed here a sensor element which is straightforward to produce is used, conditioning of the signals provided by this sensor element 100 being carried out. To this end, the measuring transducers 110 and 120 may be oriented in the recording directions 115 and 125 in the sensor element 100, subsequent conversion of the signals 116 and 126 representing the components of the physical quantity into values which represent a fraction of the physical quantity in the first reference direction 140 and the second reference direction 145, respectively, being proposed. In this way, it is advantageously possible to use a sensor element 100 which can operate with conventional methods, without the fractions, which are required for further signal processing units, of the physical quantity in the reference directions having to be omitted.

In order to provide the best possible prerequisites in relation to an expected signal/noise ratio already during the recording of the components of the physical quantity, it is furthermore proposed for the first and second measuring transducers 110 and 120 to be applied on or introduced into the carrier substrate in such a way that the recording directions 115 and 125, respectively, are arranged or placed symmetrically around an angle bisector 150 of an angle 155 between the reference directions 140 and 145, the angle 155 between the reference directions 140 and 145 in this case corresponding to 90 degrees.

In order to be able to convert the components of the physical quantity, which are represented by the signals 116 and 126, into for further data processing units, for example an airbag controller of a motor vehicle, or navigation equipment of vehicles, robots or other mobile apparatuses, a sensor signal processing device 200 is used, such as is represented in the circuit diagram of a sensor system 210 according to one exemplary embodiment of the present invention. In this case, the sensor system 210 comprises a sensor element 100 and the sensor signal processing device 200 according to exemplary embodiments of the present invention. The sensor element 100 has the first measuring transducer 110 and the second measuring transducer 120. The two measuring transducers 110 and 120 are in this case, as described above, applied or introduced on a carrier substrate 135; they acquire components of a physical quantity (for example a rotation rate and/or an acceleration) in the first recording direction 115 and the second recording direction 125 and provide corresponding signals 116 and 126.

If it was now assumed that the sensor element 100 is a conventional sensor element, a data processing unit, for example an airbag control unit or the control unit of another apparatus 220, would interpret the signals 116 and 126 provided by the sensor element 100 to the interfaces 117 and 127 as fractions xₘ and yₘ of the physical quantity, which have been acquired in the reference directions 140 and 145. This is illustrated in FIG. 2 by the axes of the reference directions 140 and 145 of the two measuring transducers 110 and 120, which are represented as being oriented orthogonally to one another. Yet since the actual recording directions 115 and 125 are oriented not orthogonally to one another, but as a function of the material, for example the lattice structure of the material of the carrier substrate 135, conversion of the components is now necessary in order to correct the direction components of the physical quantity. This direction correction, which represents a rotation of the first component into the first fraction, corresponds to a rotation by the angle α, while a rotation which represents a conversion of the second component into the second fraction corresponds to a rotation by the angle β, in relation to the first reference direction 140. This conversion or “rotation” of the components into the fractions of the physical quantity is carried out in the sensor signal processing device 200.

A circuit diagram of an exemplary embodiment of such a sensor signal processing device 200 is illustrated in FIG. 2. In this case, the first signal 116 output by the first interface 117 of the sensor element 100 is read in at a first read-in interface 230 (also referred to as the first interface), and the second signal 126 output by the second interface 127 of the sensor element 100 is read in by a second read-in interface 240 (also referred to as the second interface). In the sensor signal processing device 200, the first signal 116 and the second signal 126 are then combined in a processing unit 250 according to a first combination rule in order to determine a signal xₘ representing the first fraction of the physical quantity. In this case, the first processing rule may be configured in such a way that the first signal 116 is weighted with a first factor a₁ and added to the second signal 126 weighted with a second factor b₁. Similarly, in the processing unit 250 of the sensor signal processing device 200, the first signal 116 and the second signal 126 may be combined according to a second combination rule in order to determine a signal yₘ representing the second fraction of the physical quantity. In this case, the second processing rule may be configured in such a way that the first signal 116 is weighted with a further factor a₂ and added to the second signal 126 weighted with an additional factor b₂. In order to obtain maximally accurate conversion of the components of the physical quantity into the fractions of the physical quantity, the following values may be used as the first factor a₁, the second factor b₁, the further factor a₂ and the additional factor b₂:

$${a}_{1} = - \frac{cos β}{sin ( α + β )} ;$$

$${b}_{1} = \frac{cos α}{sin ( α + β )} ;$$

$${a}_{2} = \frac{sin β}{sin ( α + β )}$$

$${b}_{2} = \frac{sin α}{sin ( α + β )} .$$

In this way, by adequately taking into account the geometrical conditions, very accurate conversion of the individual components into the desired fractions can be carried out without compromising a high signal/noise ratio. The thereby calculated, or corresponding, fractions of the physical quantity may now be used in a further data processing unit, such as the airbag control unit or alternatively in other control units 220.

The least loss of signal/noise ratio is achieved when, in the sensor element 100, the obliquely angled measurement axes (i.e. the measurement axes which are oriented along the recording directions 115 and 125) of the primary sensor elements (measuring transducers) 110 and 120, respectively, are arranged symmetrically with respect to an angle bisector 150 of the resulting (i.e. externally provided) measurement axes 140 and 145.

The approach proposed here proves advantageous in particular when, for an arrangement of sensor elements in multiaxial acceleration and/or rotation rate sensors which use a (production) technology in which, for example, a KOH etching technology in which the etching edges are not orthogonal but are at a particular angle to one another, for example 70.53°, as described above.

In FIG. 2, a circuit diagram of one approach for the transformation of the primary measurement directions 115 and 125, rotated by the angles α and β, of the sensor elements (i.e. the measuring transducers 110 and 120) on a sensor chip 100 into the externally provided orthogonal measurement signals xₘ and yₘ (i.e. fractions of the physical quantity which are directed in the reference directions 140 and 145) is. The factors a₁, b₁, a₂ and b₂ to be used in this case are obtained by using geometrical functionalities, as described above.

Considering, as an example, the KOH etching technique as a fabrication technology for a sensor element 100, which defines for example an angle of 70.53° of the primary measurement directions 115 and 125 with respect to one another, the most favorable signal/noise ratios are obtained when the primary measurement directions 15 and 125 are arranged symmetrically with respect to an angle bisector 150 of the outer measurement axes 140 and 145. This means that in this case α=−9.735° and β=80.265° are to be selected, in relation to the first recording direction, as schematically illustrated in FIG. 2. In that case, the rms values of the noise in the measurement channels (i.e. in the signal paths for the first signal 116 and the second signal 126) increase only by a factor of about 1.06 in relation to purely orthogonally arranged primary measuring elements (i.e. measuring transducers 110 and 120, the recording directions 115 and 125, respectively, of which are arranged at an angle 130 of 90 degrees with respect to one another. All other possibilities of the arrangement lead to inferior noise values.

In particular, in this case arrangement of the obliquely angled measurement axes 115 and 125 of the primary sensor elements (i.e. of the measuring transducers 110 and 120) symmetrically with respect to an angle bisector 150 of the resulting (externally provided) measurement axes (i.e. of the reference directions 140 and 145) is therefore proposed.

The approach described here may particularly advantageously be used in future rotation rate sensors and/or acceleration sensors, if a fabrication technology which requires an obliquely angled arrangement of the primary sensor elements on the sensor chip is used.

FIG. 3 shows a flowchart of a method 300 for the production of a sensor element for acquiring a first and a second component of a physical quantity of a sensor element according to an exemplary embodiment of the present invention. The method 300 comprises a step 310 of providing a carrier substrate, which comprises a material in or on which, during processing with a predetermined processing method, it is possible to produce measuring transducers which are configured in such a way as to record the physical quantity in a first or second recording direction, a recording angle between the first and second recording directions being dependent on the material of the carrier substrate. The method 300 furthermore comprises a step 320 of arranging a first measuring transducer for recording a first component of the physical quantity pointing in the first recording direction, and a second measuring transducer for recording a second component of the physical quantity pointing in the second recording direction.

FIG. 4 shows a flowchart of a method 400 for operating a sensor signal processing device according to one exemplary embodiment of the present invention. The method 400 comprises a step 410 of reading in the first and second components of the physical quantity, and a step 420 of determining the fraction of the physical quantity in the first reference direction on the basis of a first combination rule for combining the first component with the second component and/or for determining the fraction of the physical quantity in the second reference direction on the basis of a second combination rule for combining the first component with the second component.

The exemplary embodiments described and shown in the figures are only selected by way of example. Different exemplary embodiments may be combined with one another fully or in relation to individual features. An exemplary embodiment may also be supplemented by features of a further exemplary embodiment.

Furthermore, method steps according to the invention may be repeated and carried out in a sequence other than the sequence described.

If an exemplary embodiment comprises an “and/or” conjunction between a first feature and a second feature, this is to be interpreted as meaning that the exemplary embodiment according to one embodiment comprises both the first feature and the second feature and according to another embodiment either only the first feature or only the second feature.

1. A sensor element for acquiring a first component and a second component of a physical quantity, the sensor element comprising:
a first measuring transducer configured to record the first component of the physical quantity pointing in a first recording direction; and
a second measuring transducer configured to record the second component of the physical quantity pointing in a second recording direction,
wherein the first measuring transducer and the second measuring transducer are at least one of formed on a carrier substrate and arranged in the carrier substrate, the carrier substrate comprising a material, a recording angle between the first recording direction and the second recording direction being dependent on the material of the carrier substrate.

2. The sensor element as claimed in claim 1, wherein:
the sensor element is configured to determine at least one fraction of the physical quantity in at least one of a first reference direction and a second reference direction; and
at least one of (i) the first measuring transducer is arranged such that the first recording direction is oriented at a first angle, dependent on the recording angle, in relation to the first reference direction, and (ii) the second measuring transducer is arranged such that the second recording direction is oriented at a second angle, dependent on the recording angle, in relation to the first reference direction.

3. The sensor element as claimed in claim 2, wherein the first measuring transducer and the second measuring transducer are arranged such that the first recording direction and the second recording direction are oriented symmetrically around an angle bisector of an angle between the first reference direction and the second reference direction.

4. A sensor signal processing device for operating a sensor element having a first measuring transducer configured to record a first component of a physical quantity pointing in a first recording direction and a second measuring transducer configured to record a second component of the physical quantity pointing in a second recording direction, the first measuring transducer and the second measuring transducer being at least one of formed on a carrier substrate and arranged in the carrier substrate, the carrier substrate comprising a material, a recording angle between the first recording direction and second recording directions being dependent on the material of the carrier substrate, the sensor element is being configured to determine at least one fraction of the physical quantity in at least one of a first reference direction and a second reference direction, and at least one of (i) the first measuring transducer being arranged such that the first recording direction is oriented at a first angle, dependent on the recording angle, in relation to the first reference direction, and (ii) the second measuring transducer being arranged such that the second recording direction is oriented at a second angle, dependent on the recording angle, in relation to the first reference direction the sensor signal processing device comprising:
an interface configured to read in the first component and the second component of the physical quantity; and
a processing unit configured to determine at least one of (i) a first fraction of the physical quantity in the first reference direction based on a first combination rule for combining the first component with the second component and (ii) a second fraction of the physical quantity in the second reference direction based on a second combination rule for combining the first component with the second component.

5. The sensor signal processing device as claimed in claim 4, wherein the processing unit is configured, to at least one of:
determine the first fraction in the first reference direction, in order to weight the first component with a first factor and to combine it, with the second component weighted with a second factor; and
determine the second fraction in the second reference direction, in order to weight the first component with a third factor and combine it with the second component weighted with a fourth factor.

6. The sensor signal processing device as claimed in claim 5, wherein the processing unit is configured to use at least one of the first factor, the second factor, the third factor, and the fourth factor, which is dependent on the first angle and the second angle.

7. The sensor signal processing device as claimed in claim 6, wherein the processing unit is configured to at least one of (i) use
$${a}_{1} = - \frac{cos β}{sin ( α + β )}$$
as the first factor, (ii) use
$${b}_{1} = \frac{cos α}{sin ( α + β )}$$
as the second factor, (iii) use
$${b}_{2} = \frac{sin α}{sin ( α + β )}$$
as the third factor, and (iv) use
$${a}_{2} = \frac{sin β}{sin ( α + β )}$$
as the fourth factor, α representing the first angle and β representing the second angle.

8. The sensor element as claimed in claim 1, wherein the sensor element is produced by:
providing the carrier substrate;
arranging the first measuring transducer pointing in the first recording direction and the second measuring transducer pointing in the second recording direction.

9. A method for operating a sensor signal processing device to process a signal from a sensor element having a first measuring transducer configured to record a first component of a physical quantity pointing in a first recording direction and a second measuring transducer configured to record a second component of the physical quantity pointing in a second recording direction, the first measuring transducer and the second measuring transducer being at least one of formed on a carrier substrate and arranged in the carrier substrate, the carrier substrate comprising a material, a recording angle between the first recording direction and second recording directions being dependent on the material of the carrier substrate, the sensor element is being configured to determine at least one fraction of the physical quantity in at least one of a first reference direction and a second reference direction, and at least one of (i) the first measuring transducer being arranged such that the first recording direction is oriented at a first angle, dependent on the recording angle, in relation to the first reference direction, and (ii) the second measuring transducer being arranged such that the second recording direction is oriented at a second angle, dependent on the recording angle, in relation to the first reference direction, the method comprising:
reading in the first component and a second component of the physical quantity from the sensor element; and
determining at least one of (i) a first fraction of the physical quantity in the first reference direction based on a first combination rule for combining the first component with the second component, and (ii) determining a second fraction of the physical quantity in the second reference direction based on a second combination rule for combining the first component with the second component.

10. The method as claimed in claim 9, wherein the method is stored on a non-transitory computer program product with program code configured to carry out the method when run on a device.

11. The sensor signal processing device as claimed in claim 4, wherein the sensor signal processing device is in a sensor system having the sensor element and the sensor signal processing device.
